(19) United States
(12) Patent Application Publication
(10) Pub. No.: US 2018/0302290 A1
(43) Pub. Date: Oct. 18, 2018

(54) COAP ENHANCEMENTS TO ENABLE AN AUTONOMIC CONTROL PLANE

(71) Applicant: CONVIDA WIRELESS, LLC, Wilmington, DE (US)

(72) Inventors: Shamim Akbar RAHMAN, Cote St. Luc (CA); Chonggang WANG, Princeton, NJ (US); Quang LY, IV, North Wales, PA (US); Zhuo CHEN, Claymont, DE (US); Rocco DI GIROLAMO, Laval (CA); Vinod Kumar CHOYI, Conshohocken, PA (US); Xu LI, Plainsboro, NJ (US)

(21) Appl. No.: 15/767,369

(22) PCT Filed: Oct. 14, 2016
(86) PCT No.: PCT/US2016/057046

§ 371 Date: Apr. 11, 2018

Related U.S. Application Data
(60) Provisional application No. 62/242,474, filed on Oct. 16, 2015.

(51) Int. Cl. H04L 12/24; H04W 4/70; H04L 29/06; H04W 12/06

(52) U.S. Cl. CPC H04L 41/12; H04W 4/70; H04W 12/06; H04L 41/22; H04L 63/0823

(57) ABSTRACT

A CoAP resource directory discovers, and creates a map of, autonomic nodes that meet certain security criteria for joining an autonomic control plane. The resource directory shares the map and/or neighbor relationships with the mapped nodes. The mapped nodes interact with the RD and with each other via the autonomic control plane to perform autonomic node and network self-management functions, such as self-configuration, self-protection, self-healing, and self-optimization. In addition, a CoAP option allows the autonomic control plane to be used for alternative routing of critical messages. The autonomic control plane may be observed and adjusted using a graphical user interface.

### CROSS-REFERENCE TO RELATED APPLICATIONS

This application claims the benefit of U.S. Provisional Application No. 62/242,474, filed on Oct. 16, 2015, entitled “CoAP Enhancements to Enable an Autonomic Control Plane”, the content of which is hereby incorporated by reference in its entirety.

### BACKGROUND

Machine-To-Machine (M2M), Internet-of-Things (IoT), and Web-of-Things (WoT) network deployments may employ unicast and multicast communications between nodes such as M2M/IoT/WoT servers, gateways, and devices which host M2M/IoT/WoT applications and services. Such network deployments may include, for example, constrained networks, wireless sensor networks, wireless mesh networks, mobile ad-hoc networks, and wireless sensor and actuator networks. These may use various protocols, such as Internet Engineering Task Force (IETF) RFC 7252 Constrained Application Protocol (CoAP) and IETF RFC 7390 Group Communication for the Constrained Application Protocol. CoAP is a web transfer protocol useful in constrained environments, e.g., environments with low-power devices and/or lossy communications. CoAP networks may include such devices as constrained devices, user mobile devices, sensor nodes, actuator nodes, medical devices, gateways, and network applications servers.

A CoAP endpoint is a logical and/or physical node in a CoAP network. Each CoAP endpoint may perform many roles. A CoAP sender is the originating endpoint of a message. A CoAP recipient is the destination endpoint of a message. A CoAP client is the originating endpoint of a request and the destination endpoint of a response. A CoAP server is the destination endpoint of a request and the originating endpoint of a response.

A CoAP resource is an object which has a type, associated data, and possibly relationships to other resources. CoAP uses a client/server model similar to Hypertext Transfer Protocol (HTTP). Resources are identified by a Uniform Resource Identifier (URI) and are operated on by a set of methods (GET, POST, PUT, and DELETE). A client requests an action by sending a message specifying the resource URI and the method. The server issues a response. The response potentially contains a representation of the resource.

A CoAP management entity is a logical entity that may configure and/or manage functionality of CoAP nodes and their interaction. A network management system (NMS) is a CoAP management entity and may include a graphical user interface. CoAP reuses key concepts from the current Internet Web such as Uniform Resource Identifiers (URIs), and a client/server based REST communication model. CoAP has very low overhead as it uses User Datagram Protocol (UDP) for transport, and binary message header encoding. CoAP also supports multicast distribution of messages from one client to multiple servers, as described in IETF RFC 7390 Group Communication for the Constrained Application Protocol.

CoAP uses a centralized server, called a resource directory (RD), which stores information about available URIs (resources) on other devices in the network. This allows for quick discovery of required URIs by any node via a single lookup interface on the RD. The information about the requested URI is returned by the RD in a specific format called a Link Format, as described in IETF RFC 6690 CoRE Link Format.

### SUMMARY

A CoAP resource directory discovers, and creates a map of, autonomic nodes that meet certain security criteria for joining an autonomic control plane. The resource directory shares the map and/or neighbor relationships with the mapped nodes. The mapped nodes interact with the RD and with each other via the autonomic control plane to perform autonomic node and network self-management functions, such as self-configuration, self-protection, self-healing, and self-optimization. In addition, a CoAP option allows the autonomic control plane to be used for alternative routing of critical messages. The autonomic control plane may be observed and adjusted using a graphical user interface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention. However, the invention is not limited to the specific methods, compositions, and devices disclosed.

FIG. 1 compares traditional networks to autonomic networks.

FIG. 2 is a control system diagram for an example autonomic system for home lighting.

FIG. 3 is a system diagram of an example of an autonomic light network integrated into an overall home network.

FIG. 4 is a flowchart of an example general method for forming a CoAP based autonomic control plane.

FIG. 5 is a message flow for an example system such as that depicted in FIG. 3, where the system follows a method such as that shown in FIG. 4.

FIG. 6 is an example of a map of discovered autonomic nodes and their assigned autonomic neighbors.

FIG. 7 is an example message flow whereby an RD informs autonomic nodes of their assigned autonomic neighbors via CoAP unicast messages.

FIG. 8 shows an example message flow wherein autonomic nodes form pairwise secure channels.

FIG. 9 shows an example of a backup routing configuration for an autonomic control plane.

FIG. 10 shows an example of CoAP nodes in a retail facility.

FIG. 11 shows an example of a successful request made to an autonomic node by a non-autonomic node.

FIG. 12 shows an example of communications between non-autonomic nodes.

FIG. 13 shows an example of communications between autonomic nodes.

FIG. 14 shows an example of an unsuccessful request made to an autonomic node by a non-autonomic node.

FIG. 15 shows another example of communications between autonomic nodes.

FIG. 16 shows another example of an unsuccessful request made to an autonomic node by a non-autonomic node.

FIG. 17 shows an example of a protocol stack of an RD in an autonomic control plane.

FIG. 18 shows an example of a protocol stack of an autonomic node without RD functionality.

FIG. 19 is a flow chart of an example process for the establishing of an autonomic network without the use of an RD.

FIG. 20 is an example display of a graphical user interface for monitoring and/or controlling an autonomic network.

FIG. 21 is a system diagram of an example machine-to-machine (M2M), Internet of Things (IoT), or Web of Things (WoT) communication system in which one or more disclosed embodiments may be implemented.

FIG. 22 is a system diagram of an example architecture that may be used within the M2M/IoT/WoT communications system illustrated in FIG. 21.

FIG. 23 is a system diagram of an example communication network node, such as an M2M/IoT/WoT node, gateway, or server that may be used within the communications system illustrated in FIGS. 21 and 22.

FIG. 24 is a block diagram of an example computing system in which a node of the communication system of FIGS. 21 and 22 may be embodied.

### DETAILED DESCRIPTION OF ILLUSTRATIVE EMBODIMENTS

Described herein are methods and apparatuses by which a CoAP based autonomic control plane may be established as a dedicated secure signaling path among network nodes to facilitate various autonomic functions. A CoAP resource directory discovers, and creates a map of, autonomic nodes that meet certain security criteria for joining an autonomic control plane. The resource directory shares the map and/or neighbor relationships with the mapped nodes. An autonomic neighbor is an autonomic node that is physically or logically proximate to another autonomic node.

The mapped nodes interact with the RD and with each other via the autonomic control plane to perform autonomic node and network self-management functions, such as self-configuration, self-protection, self-healing, and self-optimization. In addition, a CoAP option allows the autonomic control plane to be used for alternative routing of critical messages. The autonomic control plane may be observed and adjusted using a graphical user interface.

Autonomic functionality may be achieved by enhancements to CoAP node logic and enhancements to the CoAP family of protocols, such as CoAP RFC 7252 and CoRE RD. Specifically, for autonomic operations, the RD may change from serving a passive database role to acting in a more active role, similar to a controller. Alternatively, certain active autonomic functions can be distributed among the nodes either in addition to, or in lieu of, execution of such functions by the RD. Such functions include, for example: pro-active discovery of autonomic nodes; formation of a logical map of the network topology of the autonomic nodes; access control policy enforcement; and distribution of map information to the autonomic nodes. The map information may include neighbor relationship information, such as: access control policies; direct neighbors; and routing information. Routing information may include, for example, about communication methods available for contacting other autonomic nodes, such as the hops and physical and/or logical layer linkages. Autonomic control plane functionality may be integrated into an overall CoAP based protocol stack.

A CoAP based autonomic control plane may be used for backup routing of CoAP messages. For example, a new CoAP option may be included in a CoAP message, whereby the option notifies recipient nodes that the message should be routed via the autonomic control plane in the case that successful delivery does not occur through normal data plane operations.

Graphical user interfaces may be used to display key configuration and status information about the autonomic network. The user interface may also be used to control and configure an autonomic network, for example, by allowing required security information such as object security tokens and certificates to be provisioned in autonomic nodes. While the goal of autonomic functionality is to minimize human intervention, graphical user interfaces may be used to display configuration and status information about the autonomic network. Such a user interface may be used to input required security information, e.g. object security tokens, that may be required to enable secure autonomic control plane functioning.

Autonomic control plane functionality may be enabled through extensions and enhancements to CoAP protocols. For example, new CoRE link format resource types may be provided to identify an autonomic node, an autonomic node map, and autonomic neighbor information. A new CoRE link format device level attribute may also be used to indicate an autonomic neighbor relationship.

New processing and lookup interfaces for autonomic map formation and security options may be incorporated into RDs and/or CoAP nodes generally. For example, object security tokens may be used as input to a raw public key mode of security

Notably, these methods may also be applied in non-IoT scenarios. For example, the techniques herein may be applied in an enterprise network composed primarily of non-constrained devices such as application servers, desktops, laptops, etc.

A CoAP based autonomic control plane may facilitate a broad range of network self-management activities performed by CoAP nodes that minimize the need for human intervention. In addition to routine self-maintenance, an autonomic network may be able to adapt to unpredictable changes. An autonomic control plane allows the distributed nodes of an autonomic network to discover and signal each other in a reliable manner.

The autonomic control plane may be “out of band,” e.g., physically separate from the data plane. Alternatively, it may be “in band,” e.g., a virtual channel within the data plane. In either case, an autonomic control plane may provide reliable communication between IoT devices even in the absence of normal data plane connectivity.

The word “autonomic” has been historically used in human biology to describe the autonomic nervous system. The autonomic nervous system, for example, acts as a control system for body functions that operate mainly below the level of human conscious control, such as heart rate, digestion, perspiration, etc.

The terms “autonomic networking” and “autonomic computing” were first coined by IBM in 2001. Autonomic networks follow the same pattern as their biological counterpart. The primary aim is to create a self-managing, closed-loop system in order to overcome the growing complexity of networks. Another key goal of autonomic networking is to minimize the need for human management and intervention. J. Kephart, D. Chess, “The Vision of Autonomic Computing,” IEEE Computer Society, January 2003, pp. 41-50. IBM's original vision of autonomic networks is typically characterized as a set of four self-management properties. Namely, self-configuration, self-optimization, self-healing and self-protection as defined in Table 1.

TABLE 1

| Concept | Standard Computing | Autonomic Computing |
|---|---|---|
| Self- | Corporate data centers | Automated configuration |
| configu- | have multiple vendors | of components and systems |
| ration | and platforms. Installing, | follows high-level policies. |
| | configuring, and | Rest of system adjusts |
| | integrating systems is time | automatically and seamlessly. |
| | consuming and error prone. | |
| Self- | Systems have hundreds of | Components and systems |
| optimi- | manually set, non-linear | continually seek opportunities |
| zation | tuning parameters, and | to improve their own |
| | their number increases | performance and efficiency. |
| | with each release. | |
| Self- | Problem determination | System automatically detects, |
| healing | in large, complex systems | diagnoses, and repairs localized |
| | can take a team of | software and hardware problems. |
| | programmers weeks. | |
| Self- | Detection of and recovery | System automatically defends |
| protec- | from attacks and cascading | against malicious attacks and |
| tion | failures is manual. | cascading failures. It uses |
| | | early warning to anticipate |
| | | and prevent system-wide failures. |

To avoid the need for humans to keep manually, or semi-manually configuring and managing networks, ideally human input to autonomic networks should be limited to: inputting top level policies; receiving aggregated reports; and enjoying proper system functioning. Everything else is taken care of by the network nodes themselves, either acting singly or cooperatively.

The research branch of the IETF, called the Internet Research Task Force (IRTF), has set forth concepts for autonomic networks in the following publications: IETF Definitions and Design Goals—RFC 7575; IETF General Gap Analysis for Autonomic Networking—RFC 7576; and IETF Autonomic Networking Use Case for Distributed Detection of SLA Violations. An IETF working group (WG) called the Autonomic Networking Integrated Model and Approach (ANIMA) has been established to explore standardization of protocols for autonomic solutions.

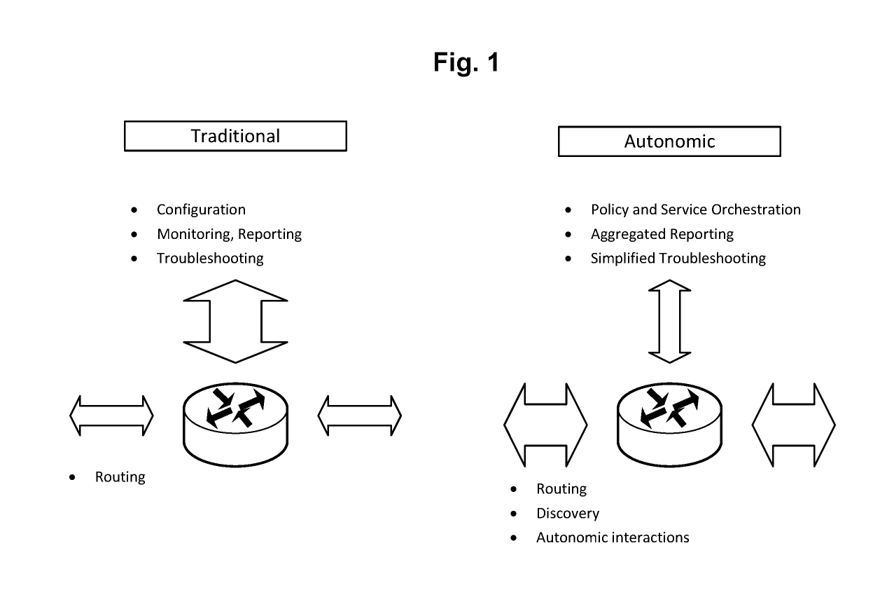

FIG. 1 compares traditional networks to autonomic networks. It is based on the IETF's Vision of Network Evolution Due to Autonomic Networks, http://www.ietf.org/proceedings/90/ucan.html, item 2., page 2. The traditional network node to the left has a relatively large amount of communications from above with regard to configuration, monitoring, reporting, and troubleshooting, and relatively little communications laterally with its peers in this regard. Conversely, the autonomic node to the right has relatively little control communications from above for policy and service orchestration, aggregated reporting, and simplified troubleshooting. The autonomic node has relatively robust communications with its peers in the autonomic network for these functions. The essence of the autonomic approach is to minimize operator interventions and network management system (NMS) dependencies.

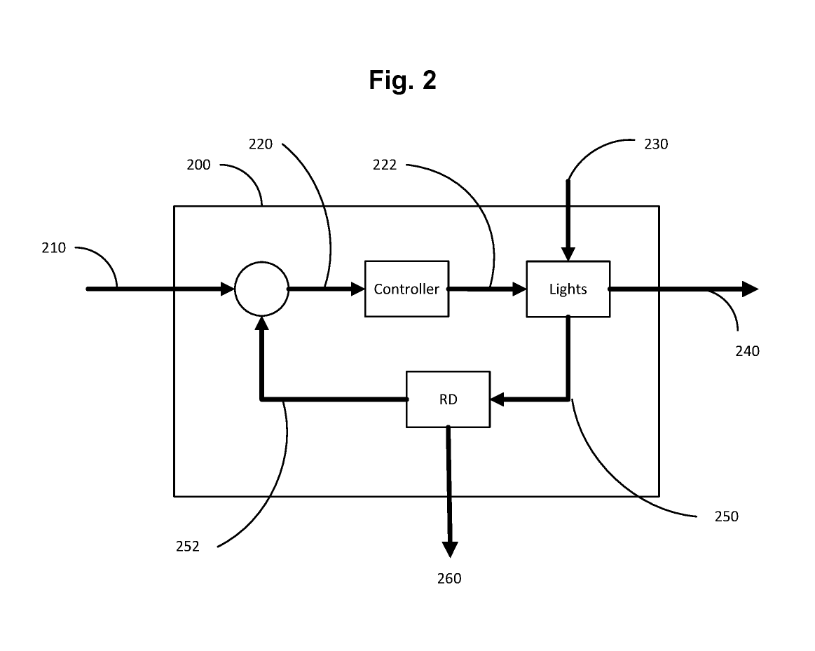

FIG. 2 is a control system diagram for an example autonomic system 200 for lighting devices in the kitchen of a home. An external input signal 210 is received by the system 200. The input signal 200 may be a command from a human interface unit, a sensor, or a timer, etc. For example, a human operator may use a touchscreen to turn the lights on or off. Alternatively, infra-red motion sensors may be used to detect whether a person is present and adjust the lights accordingly. The external output of the autonomic network 200 is the behavior of the lights.

The input 210 is forwarded as a CoAP control signal 220 to the controller. The controller in turn sends a CoAP control signal 222 to the lights. The lights may have other signals and/or interference 230 affecting them. For example, as network devices, the lights may be under a security attack via the Internet, or experiencing intermittent communications. The result 240 includes actions, such as lights turning on or off.

The result 240 includes a CoAP feedback signal 250 that goes to a resource directory (RD). This provides an autonomic feedback signal loop whereby devices in the network may detect errors and take control actions accordingly. In this example, the RD contains autonomic logic for self-management properties of the system 200. If an error is detected in the response by the lights, the RD may generate a CoAP feedback signal 252 to be fed back to the controller to trigger corrective action. The autonomic logic may include, for example, machine learning, heuristics, fuzzy logic, and other computation methods that enable autonomic behaviors of self-configuration, self-optimization, self-healing, and self-protection.

The RD also generates and transmits a report 260 to an external NMS. The report 260 may include indications of: inputs received; actions attempted; and the success or failure of the attempts. For example, report 260 may reflect that an even occurred from which autonomic network was unable to recover from without human intervention. For example, the report may indicate that a light bulb has physically burnt out and needs to be manually replaced.

Note that input signal 210 may not necessarily specify which lights should turn on. For example, the device generating input signal 210 may have no knowledge of what lights, if any, are available. The autonomic network devices, i.e., the controller, the RD, and the lights, may themselves work together to determine how to best respond to the request.

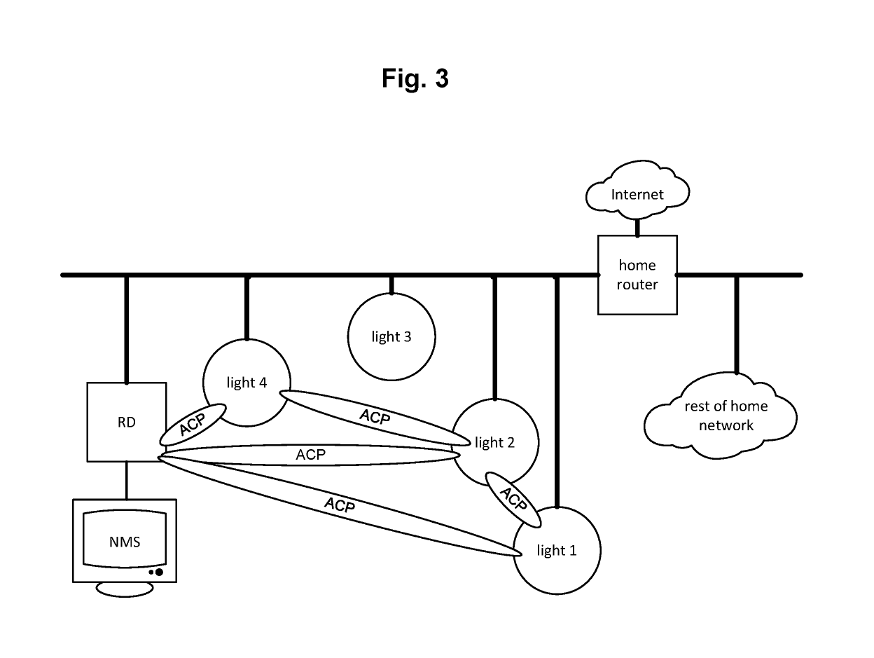

FIG. 3 shows an example of an autonomic light network integrated into an overall home network via a home router. There are a number of autonomic network elements, including light 1, light 2, light 4, and a resource directory (RD). Other devices include light 3 and an NMS for the autonomic network. The autonomic network elements, light 3, and other devices on the rest of the home network are connected via the home router, which also connects to the Internet. The autonomic network elements have stable link layer connectivity with each other on an autonomic control plane (ACP). For example, these nodes may be connected via Ethernet or Wi-Fi connections. Thus, even if the home router were not activated or available for some reason, some connectivity is available among the network elements via the autonomic control plane. In this example, the home network may be Internet Protocol version 6 (IPv6) based. All the elements of the autonomic network belong to the same link local IPv6 domain, which means effectively that they are logically one hop away from each other at the IP layer. The RD is co-located with the NMS. The NMS has input and output interfaces for a human operator.

Light 3 does not support autonomic functions. Therefore light 3 does not participate in the autonomic control plane. The other lights, light 1, light 2, and light 4, along with the RD, do support autonomic functions and so are able to participate in an autonomic control plane.

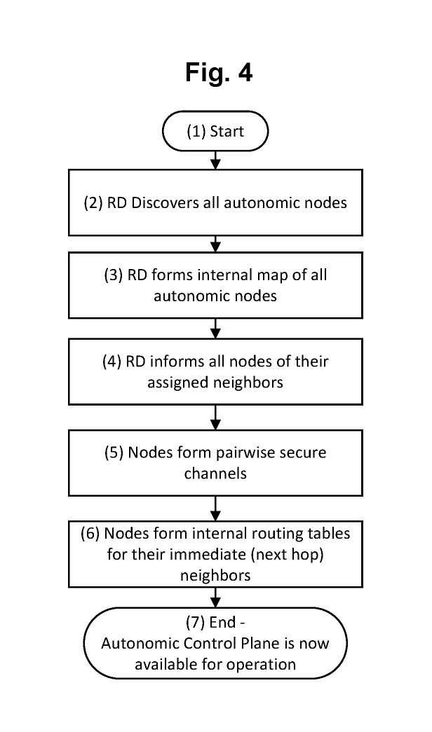

FIG. 4 is a flowchart of an example method for forming a CoAP based autonomic control plane. In this example, the nodes are physically present. One of them is an RD, as also seen in the examples of FIG. 2 and FIG. 3. As defined in standard CoAP, an RD performs a type of control or centralization function. For example, the RD is the central point to store and search for URIs in a CoAP based network. In the example of FIG. 4, the RD also performs a controller-like role in the formation of the CoAP based autonomic control plane. In step 2, the RD discovers all the autonomic nodes. This may involve the exchange of security credentials, such as certificates and/or tokens, among the autonomic nodes. In step 3 the RD forms an internal map of the autonomic nodes. In step 4, the RD informs each of the other autonomic nodes of their assigned neighbors based on the map. In step 5, each node then forms a pairwise security channel with each of its assigned neighbors. In step 6, each node also forms an internal routing table for their next hop neighbors, and notes whether they have multiple physical interfaces such that routing may involve a packet coming in on one physical interface and then being sent out on a separate physical interface.

In step 7, the autonomic control plane (ACP) is available for use by the nodes to enable their self-management properties. For example, nodes may now use their secure connections to send critical control messages through the ACP. For example, certain messages may contain sensitive data which they may not want to send in the general network data plane. Similarly, if the network data plane is not fully functional, e.g. if DNS is not active, ACP functionality may be used as an alternative way to send control messages between autonomic nodes.

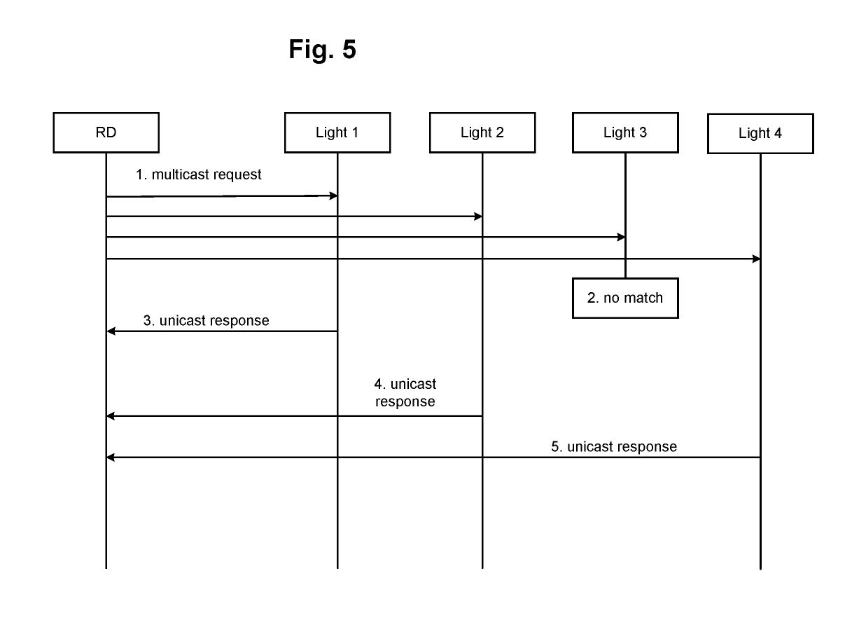

FIG. 5 is an example message flow for a system, such as the system depicted in FIG. 3. Here in the system is following a method such as that shown in FIG. 4. In FIG. 5, message 1 is a CoAP multicast query sent from the RD to lights 1-4, whereby the RD seeks to discover which nodes are autonomic nodes, e.g., devices which support autonomic logic/functionality. Message 1 may include a security certificate of the RD.

In this example, the lights and the RD are assumed to be on the same link-local IPv6 address space for IPv6 address auto-configuration and multicast scope. However other configurations may be supported, such as configurations with site-local multicast scope.

In step 2, light 3 processes the multicast query message 1. However, light 3 is not an autonomic node: none of its functionality matches the traits specified in the query. Therefore, since light 3 does not support autonomic logic, it does not respond to message 1.

Light 1, light 2, and light 4 are autonomic nodes. These three lights process the query in steps not shown, and then send CoAP unicast response messages 3, 4, and 5, respectively, in which each light indicates to the RD that it is an autonomic device. Messages 3, 4, and 5 may contain other information useful to the RD, such as the location of the light. For example, messages 3, 4, and 5 may contain GPS coordinates or indoor position information about lights 1, light 2, and light 4.

To confirm that the RD can be considered a trust anchor for the autonomic devices, Lights 1, 2, and 4 may examine the RD's security certificate prior to responding. For example, the RD's security certificate may have been previously preinstalled into the light's operating system at the factory, identifying the RD as a root certificate for trust. Similarly, each light may also return a security credential, such as a certificate or token, to the RD, whereby the RD may confirm the eligibility of these lights to participate in the ACP.

The RD may optionally send the multicast query message 1 periodically, for example, once every 15 minutes. This would allow RD to detect changes in topology, such as lights burning out or new lights being installed. This would also allow discovery of nodes that potentially missed the multicast request because they had, for example, been busy asleep at the time of sending of the previous multicast query.

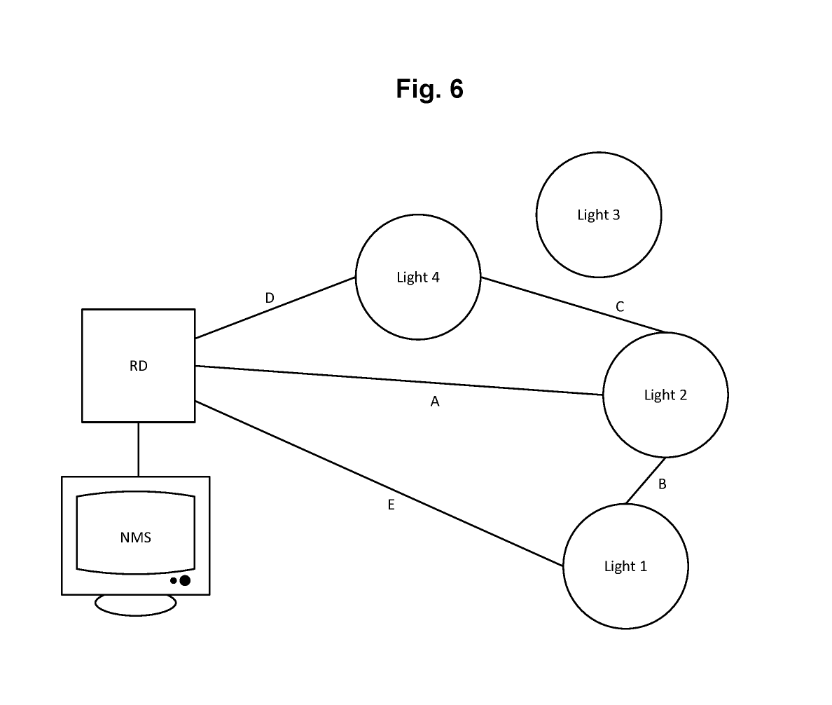

FIG. 6 is an example of a map of discovered autonomic nodes and their assigned autonomic neighbors. The devices shown in FIG. 6 are again among those shown in FIG. 3. The map is formed by the RD using the responses to the queries to discovery autonomic devices. For example, the RD may form a graph of relative position and distance of each node based on location information received from each device, e.g., indoor positioning information. The RD may also verify the received security credential from each device to confirm that it is authorized to join the autonomic control plane.

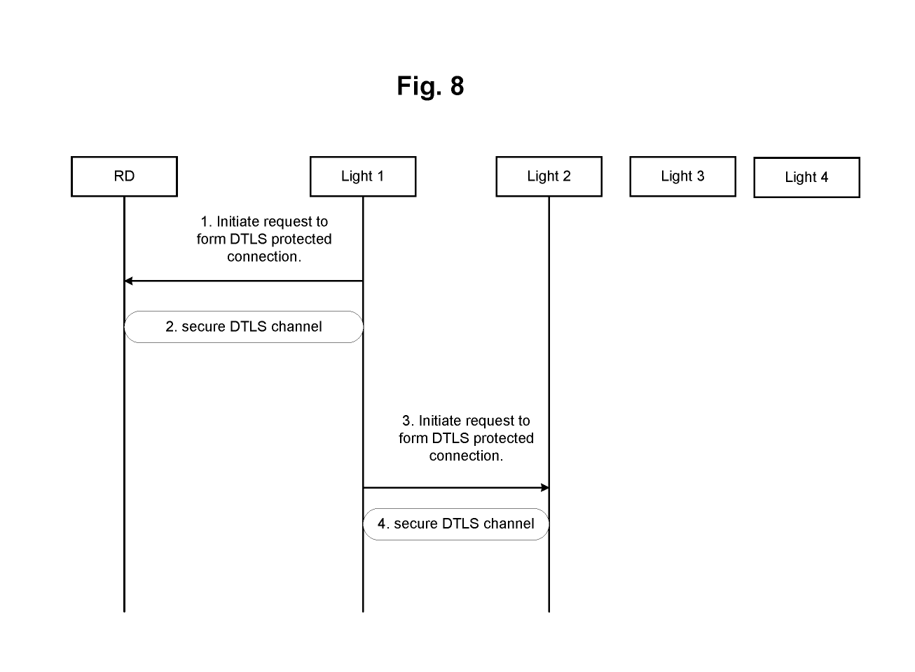

FIG. 6 shows a visual representation of the relative positions of the RD and light 1, light 2, and light 4. Light 3 is shown in FIG. 8 without any connections to highlight the fact that is not part of the map, since light 3 is not an autonomic device. There are five pairwise autonomic connections in this map, A, B, C, D, and E.

The structure of the map may be represented in the RD via CoAP web-linking which is an efficient manner to indicate neighbors. Specifically, the RD may assign each node a link, e.g., a URI, for each of their closest physical autonomic neighbors.

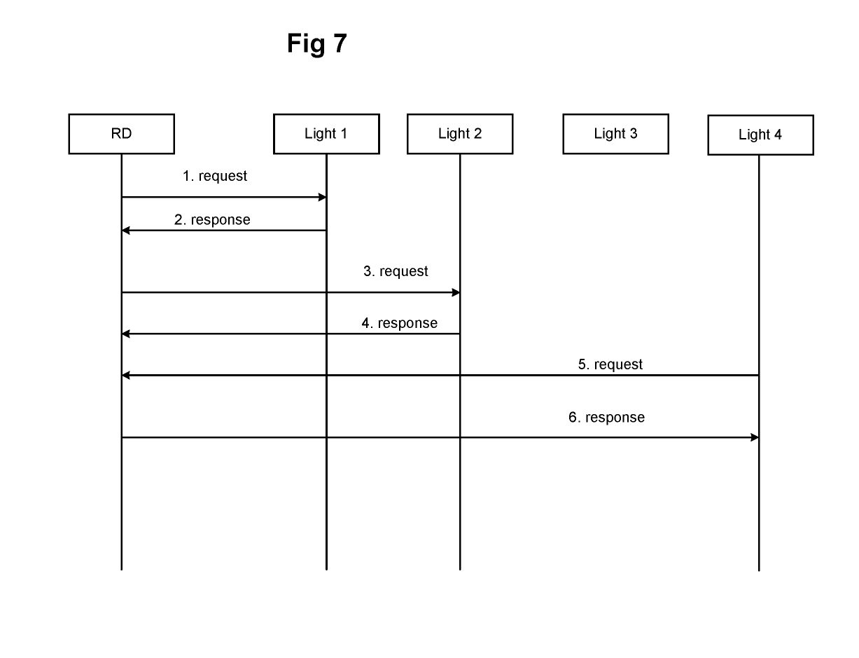

FIG. 7 is an example message flow whereby an RD may inform autonomic nodes of their assigned autonomic neighbors via CoAP unicast. The devices shown in FIG. 7 are again among those shown in FIG. 3. Prior to the messages shown in FIG. 7, the RD has sent its security credential to indicate that the information can be trusted, e.g., as part of a method such that shown in FIG. 5.

Referring to FIG. 7, in a unicast CoAP POST message 1, the RD informs light 1 of its autonomic neighbors, which are shown in FIG. 6. In this example, the autonomic neighbors of light 1 are light 2 and the RD. Light 1 stores this information in a step not shown, and transmits acknowledgement message 2 to the RD.

Similarly, in message 3 the RD informs light 2 of its autonomic neighbors, which are lights 1, light 4, and the RD. Light 2 stores the information and transmits an acknowledgement response message 4 back to the RD. Likewise, the RD informs light 4 of its autonomic neighbors in message 5. The neighbors of light 4 are light 2 and the RD. Light 4 stores the information and transmits acknowledgement 6 back to the RD.

Although light 3 is on the general network, it is not autonomic node, and not part of the ACP. Therefore no map information is shared with light 3.

In the example of FIG. 7, unicast CoAP messages are sent sequentially by the RD to each of the lights individually to inform them of their neighbors. Alternatively, the RD may send the complete neighbor map once to a multicast address. The receiving nodes may then extract their relevant neighbor information from the complete neighbor map.

FIG. 8 shows an example message flow wherein autonomic nodes form pairwise secure channels with the neighbors previously identified by the RD. The devices shown in FIG. 8 are again among those shown in FIG. 3. Prior to the messages shown in FIG. 8, the RD sent its security certificate to each of the autonomic nodes to identify the RD as a trust anchor for the autonomic network. This security certificate can then be used to initiate a standard Datagram Transport Layer Security (DTLS) encrypted connection, for example, between the RD and light 1, in accordance with CoAP RFC 7252. The encryption may also be complemented with an integrity protection mechanism which ensures that the received data is the same as the data that was transmitted. Encryption guarantees data confidentiality and integrity protection guarantees that the data was not altered after transmission.

Referring to FIG. 8, in this example, light 1 sends message 1 to request the formation of a standard DTLS secured connection. In step 2 the RD and light 1 form such a connection. This is the pairwise connection E shown in FIG. 6.

Referring again to FIG. 8, light 2 similarly sends a request message 3 to light 1. In step 4, light 1 and light 2 form a standard DTLS secured connection. This is the pairwise connection B shown in FIG. 6. By similar steps, not shown in FIG. 8, the other pairwise connections A, C, and D of FIG. 6 may be established.

Once the DTLS connections are setup, the CoAP messages exchanged on the autonomic control plane may be secured via encryption and data integrity. In addition, for further security, the lights and the RD may be configured to accept only those control action requests which originate within the autonomic control plane. For example, while the autonomic nodes may continue to read CoAP GET requests originate outside the autonomic control plane, they may be configured to act only upon CoAP PUT, POST, and DELETE requests coming from trusted members of the autonomic control plane. In the example of the network shown in FIG. 3, this protects the lights from being turned off by a security attack entering the home via the Internet.

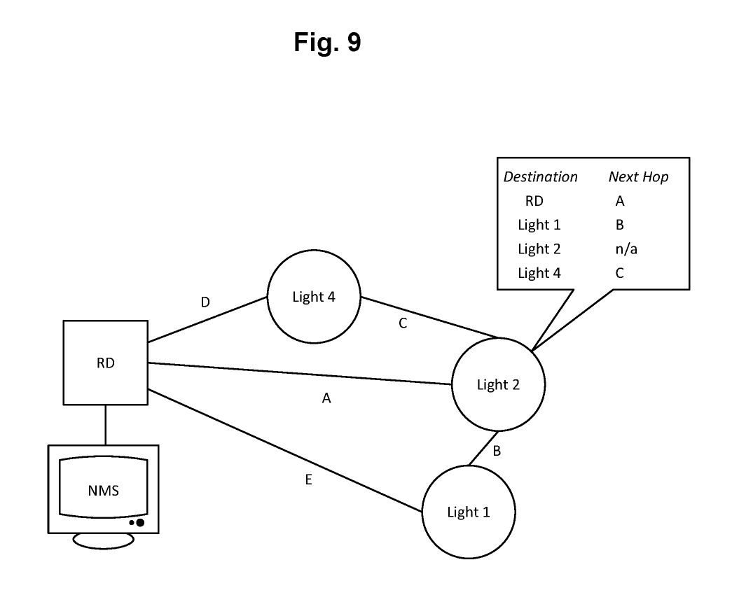

FIG. 9 shows an example of a backup routing configuration for an autonomic control plane. The devices shown in FIG. 9 are again among those shown in FIG. 3. As mentioned previously the autonomic control plane may act as a virtual channel of the general network data plane, whereby the autonomic control plane runs in-band on the network data plane but is logically separate from the rest of the data plane traffic. If the general network data plane routing is active, then autonomic control plane traffic will be routed as any other data plane IP traffic. However, when the general data plane is not fully functional, e.g., when the home router of FIG. 3 is not working properly, then backup autonomic routing may be available as shown in FIG. 9. This optional feature may take advantage of the node performing the backup routing having multiple physical interfaces, whereby routing involves a packet coming in on one physical interface and then being sent out on a separate physical interface.

In FIG. 9, light 2 is depicted as having a routing table of its direct autonomic neighbors. Each node of the autonomic map may have such a table. Each table may include information about which interfaces are available for each hop. Incoming CoAP messages may then be routed as required by each node within the autonomic control plane based on the logical topology map created and distributed by the RD. This provides a robust topology even if some members of the autonomic network themselves, such as the RD, are disabled. The destination identifiers shown in the routing table of FIG. 9 may be derived from the identities used in DTLS exchanges.

Internal routing tables for the autonomic control plane nodes may be determined entirely by the RD. Alternatively, internal routing tables may be determined by each node for itself. In addition, internal routing tables for each node may be created by each node based both upon a neighbor list sent by the RD and the node's lights own knowledge of its neighbors.

Notably, multiple separate autonomic control planes may operate in a single facility. For example, the home depicted in FIG. 3 may also include a home fire and burglary alarm system including, for example, smoke detectors, door sensors, and alarms, not shown. Such a set of security nodes may form a separate autonomic control plane, which is independent of the lighting autonomic control pane used as an example above, by following similar steps to those shown above for the kitchen lighting system.

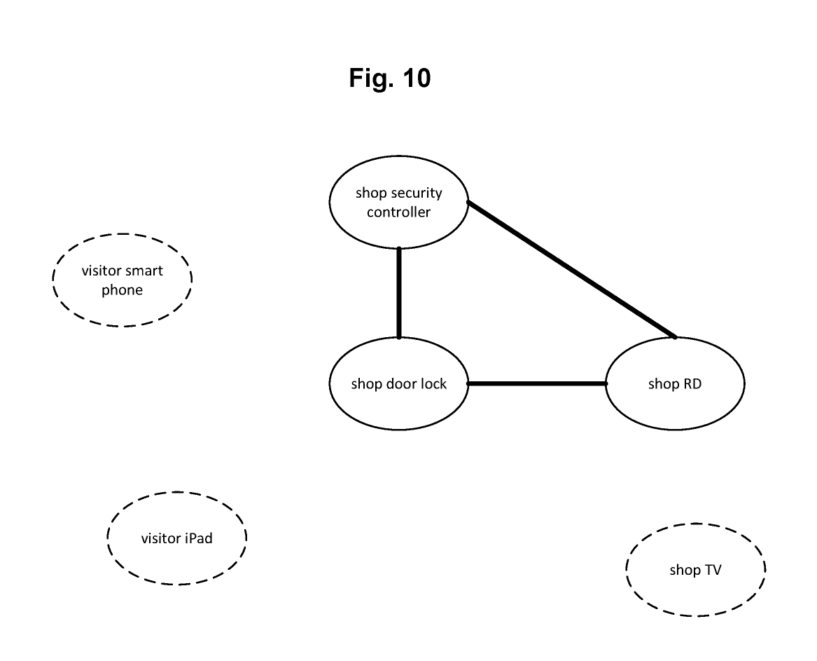

FIG. 10 shows an example of CoAP nodes in a coffee shop. The nodes in the coffee shop are connected via a Wi-Fi router, not shown, which allows the nodes to connect to each other and to the Internet. For example, Wi-Fi router may be open, with no L2 security active. The Wi-Fi provides a general network data plane that connects all nodes.

FIG. 10 includes an autonomic control plane with three nodes: a security controller, a door lock, and an RD. The autonomic control plane is running logically on top of the Wi-Fi general network data plane. The autonomic control plane was previously formed, e.g. via discovery, mapping, and security connections, etc., and is ready to be used for autonomic functioning.

The other nodes, including the shop TV, visitor smart phone, and visitor iPad, are not part of the autonomic control plane. These other nodes may communicate with each other, or with an autonomic node, via Wi-Fi as required. All the nodes have Internet connectivity if required through the Wi-Fi router.

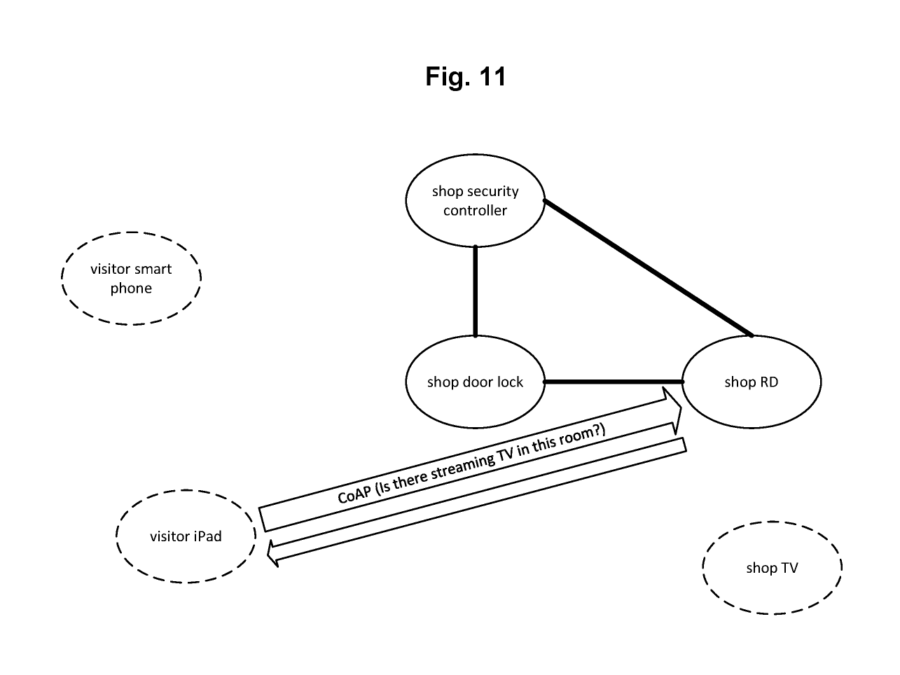

FIG. 11 shows an example of application messaging that is sent over the network data plane. The devices and their configurations are as described in reference to FIG. 10. Here in FIG. 11, the iPad, which is outside of the autonomic control plane, sends a message to the RD. The RD is part of the autonomic network. The message is an application layer message over CoAP requesting the RD to identify any streaming video players in the coffee shop. Assisting in such a search for a resource is a typical RD function. In this example, the RD replies with the URI of the TV which hosts a streaming video functionality in the coffee shop. The messages between the iPad and the RD are unprotected. The messages are not encrypted since the Wi-Fi is open and there is no DTLS connection between the iPad the RD.

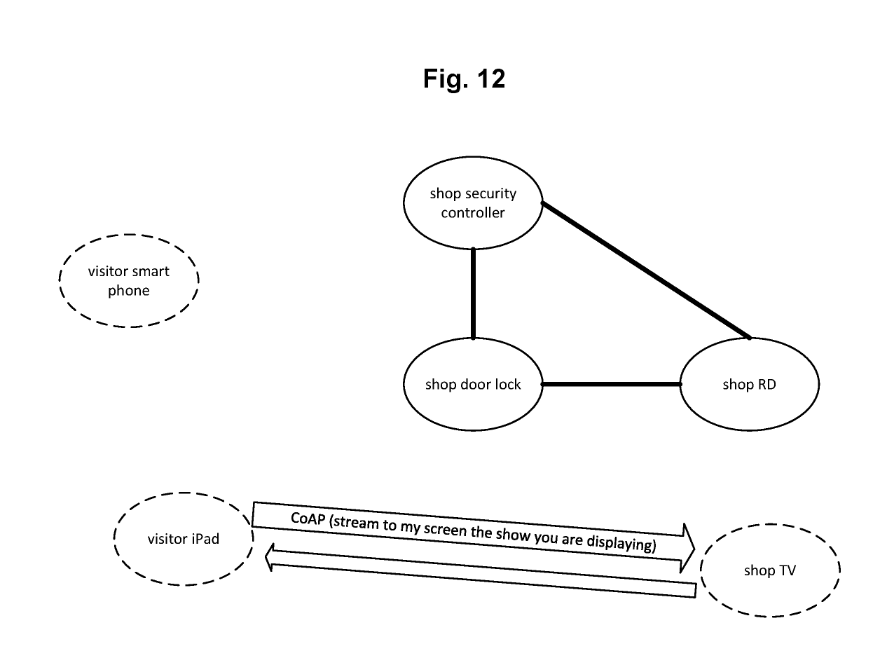

FIG. 12 shows another example of application messaging that is sent over the network data plane. Here again, the devices and their configuration is as described in reference to FIG. 10. The communications in FIG. 12 occur after the messaging FIG. 11. In FIG. 12, no autonomic control plane node involved. With the knowledge of the TV that it received previously, the iPad now sends a request to the TV requesting a streaming session to be sent to it. The TV responds by sending a stream to the iPad. These messages are also unprotected since the Wi-Fi is open and there is no DTLS connection between the iPad the TV.

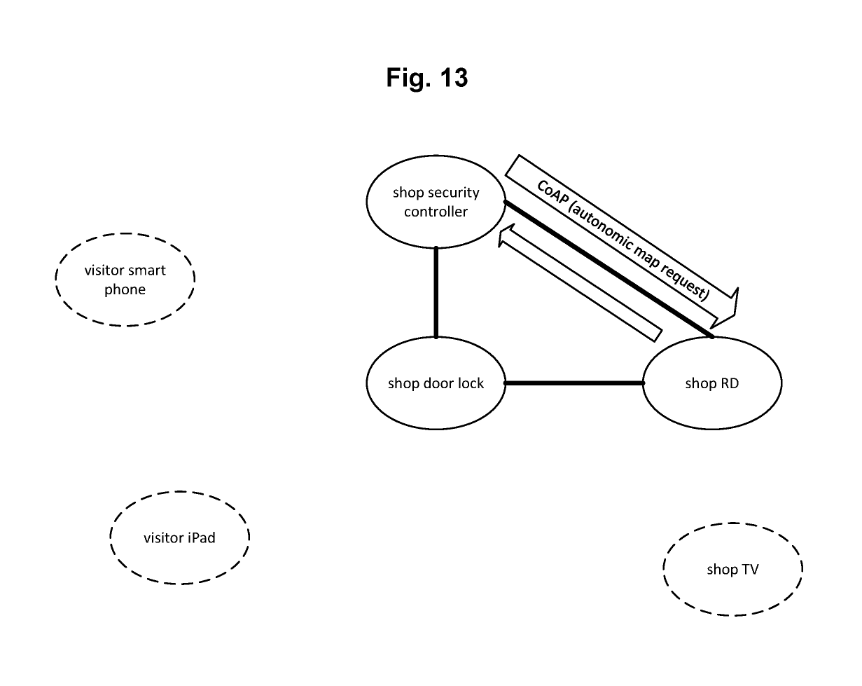

FIG. 13 shows an example of messaging inside the autonomic control plane. Here again, the devices and their configuration is as described in reference to FIG. 10. Here in FIG. 13, the security controller transmits a CoAP message to the RD requesting the latest autonomic neighbor map. Note that the communication is physically done over Wi-Fi, i.e. network data plane, but it is sent protected by DTLS, since the message is logically part of the autonomic control plane which was set up with DTLS secure connections at start up.

Prior to responding, the RD performs an access control check. The map information is sensitive, since it reveals topology information on layout of the autonomic network. Therefore the RD checks that the security controller is part of the autonomic control plane. It is possible that the RD had a DTLS connection with a non-autonomic node, so just having a DTLS connection is not a sufficient check. The RD knows the identity of the members of the autonomic control plane from their security credentials. These credentials are used for an access control list for autonomic functions. Since the access control checks pass, the RD responds to the security controller with the current autonomic neighbor map.

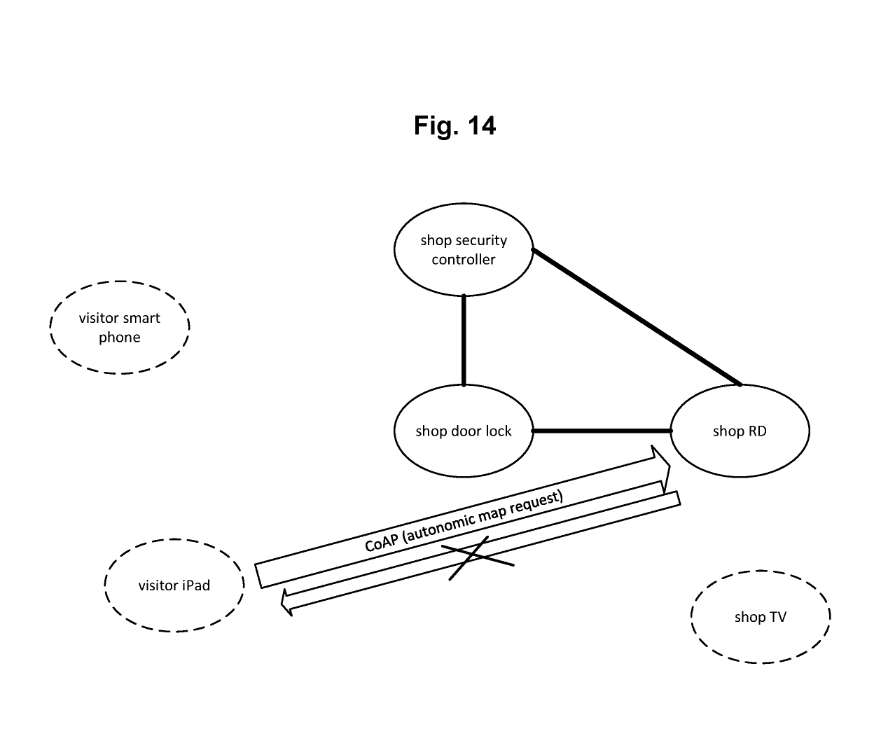

FIG. 14 shows an example of messaging to the autonomic control plane from an outside node. Here again, the devices and their configuration is as described in reference to FIG. 10. The iPad sends a CoAP message to the RD requesting the latest autonomic neighbor map. The message is unprotected since it is sent over the general network data plane and not over the autonomic control plane. The RD checks the request against its access control list and finds that the iPad is not part of the autonomic control plane. Therefore the RD rejects the request since it will not share sensitive map information with node outside of the autonomic plane.

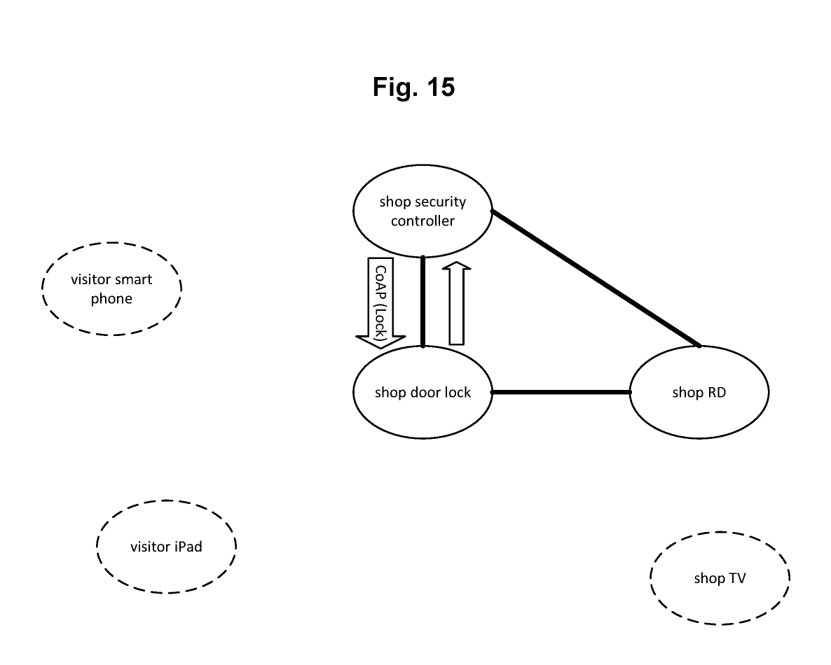

FIG. 15 shows an example of messaging inside the autonomic control plane. Here again, the devices and their configuration is as described in reference to FIG. 10. In FIG. 15, specifically, the security controller sends the door lock an application request to lock. Note that the communication is physically done over Wi-Fi, i.e., the network data plane, but it is sent protected by DTLS since it is logically part of the autonomic control plane which was set up with DTLS secure connections at start up. The door lock performs an access control check before it answers the request. Specifically, since the request is critical, the door lock checks that the security controller is part of the autonomic control plane before responding. It is possible that the door lock had a DTLS connection with a non-autonomic node, therefore just having a DTLS connection is not a sufficient check. The door lock knows the identity of the members of the autonomic control plane that it should accept requests from. Such information was transferred to the door lock as part of the autonomic map from the RD. The door lock uses this information in forming an access control list for autonomic functions. Since the access control checks pass, the door lock responds to the security controller request and also locks the door.

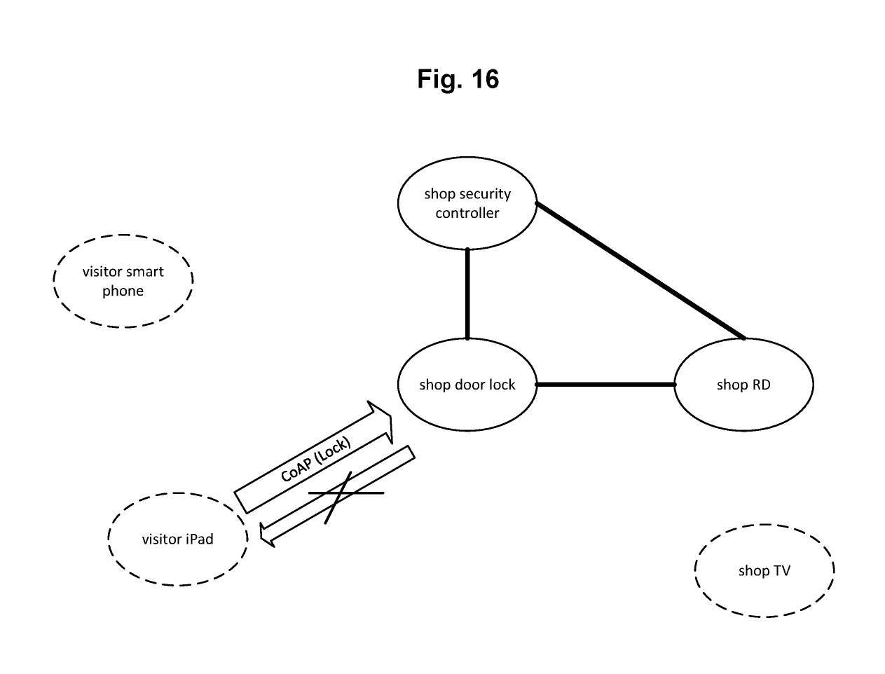

FIG. 16 shows another example of messaging to the autonomic control plane. Here again, the devices and their configuration is as described in reference to FIG. 10. Here in FIG. 16, the iPad sends the door lock an application request to lock. The message is unprotected since it is sent over the general network data plane and not over the autonomic control plane. The door lock checks the request against its access control list and finds that the iPad is not part of the autonomic control plane. Therefore the door lock rejects the request since it will not execute a critical request from a node that is not on the autonomic control plane.

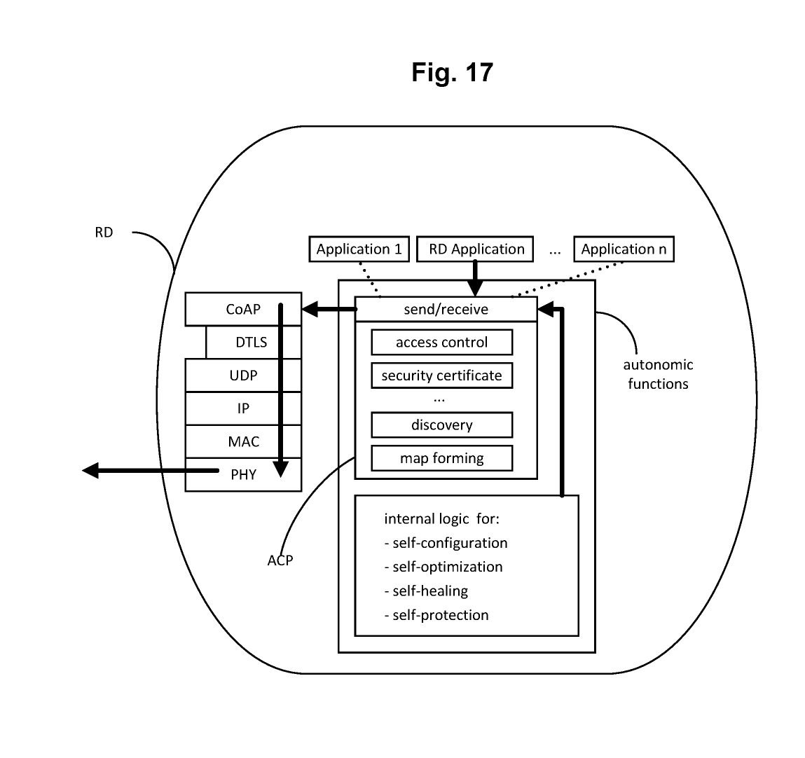

FIG. 17 shows an example of a protocol stack of an RD for use in an autonomic control plane. The autonomic control plane (ACP) functions include such operations as autonomic node discovery, map forming, map distribution, secure channel formation, backup autonomic plane message routing, and access control functions. Self-management property logic may include machine learning, heuristics, fuzzy logic, etc., and use the autonomic control plane for signaling to/from other autonomic nodes to enable the autonomic behaviors such as of self-configuration, self-optimization, self-healing, and self-protection.

The autonomic control plane may be used by the RD for messages to both autonomic and non-autonomic nodes. If the other recipient node is not an autonomic node, then DTLS encryption may not be triggered. When triggered, the DTLS module will use the security certificate pre-configured in the autonomic control plane. Preferably, access control checks are performed on all incoming and outgoing message, regardless of whether the other nodes autonomic or non-autonomic.

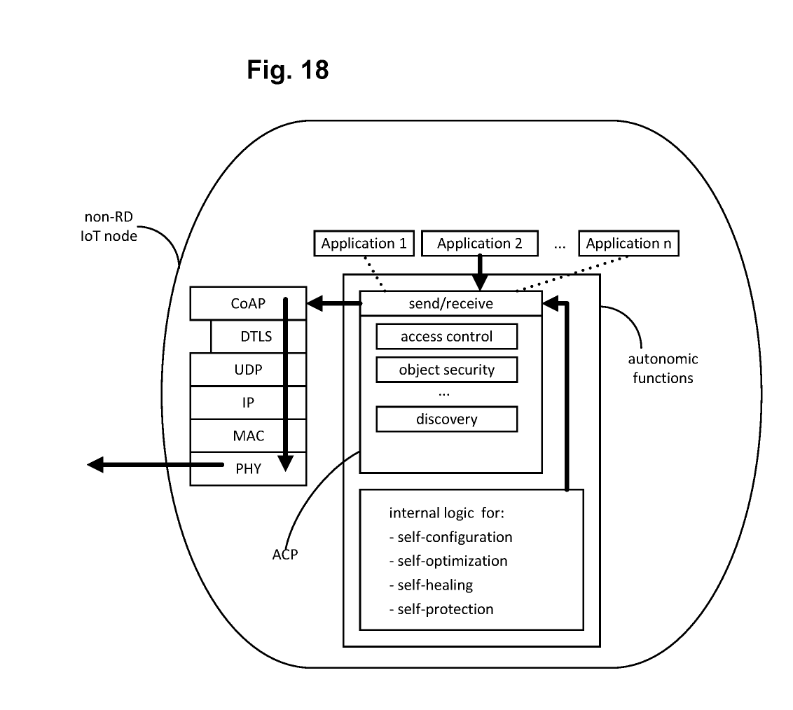

FIG. 18 shows an example protocol stack of for autonomic nodes other than the RD. There are many similarities of the autonomic control plane with the RD described above. The key differences are that an object security module may be pre-configured and used instead of a security certificate.

As described in CoAP RFC 7252, an RD has a full security certificate. The certificate may be an X.509 certificate or equivalent. Such an RD has an asymmetric security public/private key pair, and an identity based on the X.509 certificate information.

A list of root trust anchors may be used by an autonomic node to validate the certificate of an RD or other node. Such a list may be provisioned prior to deployment within the operating system of the autonomic node performing the validation. Alternatively, a node may be so provisioned after it is deployed in the field.

For example, in reference to the devices shown in FIG. 10, the RD may be provisioned as the root trust anchor in the operating systems of the shop door lock and of the shop security controller. This is done with the nodes that are intended to form an autonomic control plane. The shop TV, for example, while one of the permanent nodes in the coffee shop, is not intended to be part of the autonomic control plane, and therefore is not so provisioned. The provisioning may be done in the factory before the devices are shipped. Alternatively, the provisioning could be done by a security company that provides the security nodes as a set to the coffee shop. This could be done in the security company facilities before the nodes are shipped to the store. Another option is for an end user to enter the necessary information via a graphical user interface, e.g., on a network management system (NMS) operating in the coffee shop after the nodes are physically installed there.

The RD may exchange security certificates with the other nodes early on, e.g., during initial discovery. This allows trusted DTLS connections to be setup between the RD and the other nodes.

Nodes other than an RD may use the “raw public key mode” described in Section 9 of CoAP RFC 7252. This mode uses an asymmetric security public/private key pair but no other certificate. For example, no X.509 certificate is required. This allows DTLS connections to be setup with the keys. The identity of each node may be based on such a public key.

Section 9 of CoAP RFC 7252 offers an alternate to certificate validation that should be considered for secure deployments. An application object security token may be used for all nodes in the autonomic control plane other than the RD. Such an application object security token may be pre-loaded onto each such node. Like a security certificate, the application object security token may be provisioned in a node at the factory, by a retailer prior to shipment to the point of use, or after installation via a graphical user interface and/or NMS.

The object security token may then be used as an alternate to certificate validation. Each node may exchange its raw public key and object security token with the RD and the other nodes so that trusted DTLS connections may be established. The RD may track the identity of all the nodes joining the autonomic network so that it may perform access control checks when they access the RD. The RD may also transmit an access control list to the other nodes of the autonomic network as part of the autonomic neighbor map information that it sends to the other nodes at start up.

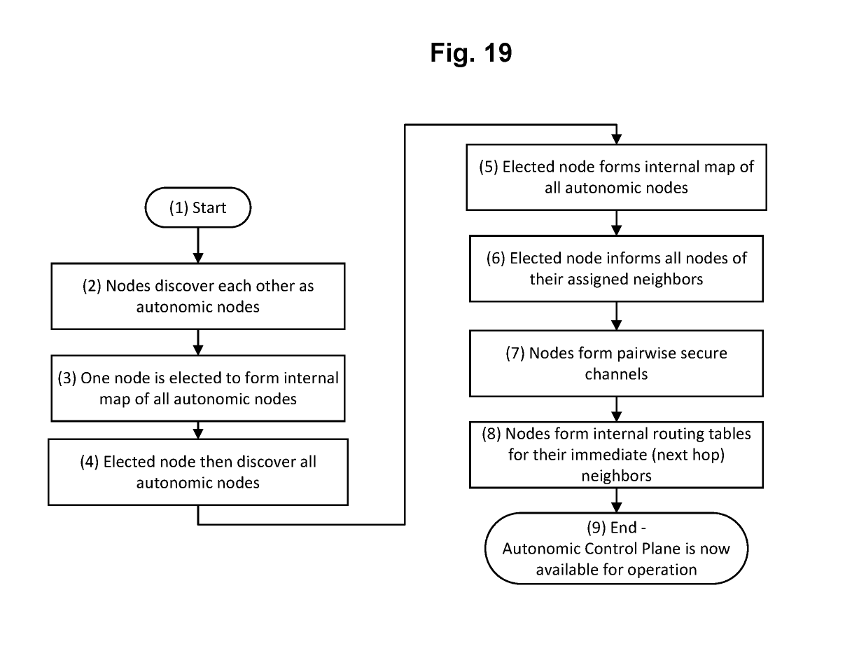

FIG. 19 is a flow chart of an example process for the establishing of an autonomic network without the use of an RD. Where an RD exclusively performs a controller role in the formation of a CoAP based autonomic control plane, the RD may also become a single point of failure. This defeats the goal of network self-management. One solution is to have a backup or mirror RD.

Another approach is to follow the method outlined in FIG. 19. At the start in step 1, no RD is available. The RD is either absent or malfunctioning. In step 2, each of the non-RD autonomic nodes undertakes to discover each other. In step 3, one of the nodes is “elected” to form the internal map of all autonomic nodes. This elected node may, for example, simply be the first autonomic node to power up in the network.

In step 4, the elected node then discovers all the available autonomic nodes. This may be done, for example, by following a method similar to that described in reference to FIG. 5, whereby the elected node uses a multicast query and collects unicast responses.

In step 5 of FIG. 19, the elected node generates a map of all the available autonomic nodes. In step 6, the elected node then informs the other autonomic nodes of their assigned neighbors based on the map generated in step 5.

In step 7, each node then forms pairwise security channels with their direct neighbors. In step 8, each node also forms an internal routing table for their next hop neighbors.

At the end of the method in step 9, the autonomic control plane is available for use by the nodes to enable their self-management properties. For example, nodes may use their secure connections to send critical control messages which they may not want to send in the general network data plane. Similarly, if the network data plane is not fully functional, e.g. if DNS is not active, the newly established autonomic control plane may be used to send the control messages.

A CoAP based autonomic control plane may be achieved through modification and extension of the IETF CoAP standard. For example, CoRE Link Format may be extended to support an “autonomic_device” resource type (rt), whereby an RD sends out a periodic multicast request with the RD security certificate to detect changes in its autonomic network composed of IoT devices, such as the following:
CoAP GET/.well-known/core?rt=autonomic_device

If the receiving IoT node has an autonomic resource it may reply as follows:
Response: 2.05 Content
   <URI>; rt=“autonomic_device”
   Autonomic Info+Device Security certificate

Similarly, CoRE Link Format may be extended to support a device level attribute indicating whether the device is either an “autonomic_device” or not. This may be an alternate embodiment to using “rt=autonomic_device,” which indicates status on a resource by resource basis. The extension device level device type (dt) may, for example be defined as dt=“autonomic_device” or dt=“non_autonomic_device” whereby an RD sends out a periodic multicast request to detect changes in its autonomic network. The multicast request may be as follows:
CoAP GET/.well-known/core?dt=autonomic_device

If the IoT device is an autonomic_device it will reply as follows:
Response: 2.05 Content
   <URI>; dt=“autonomic_device”
   Autonomic Info+Security certificate

Further, CoRE Link Format may be extended to support a “total_autonomic_map” resource type (rt). For example, an IoT device may sends out the following unicast request to the RD to get a copy of the map of all the autonomic neighbors of a light 1:
CoAP GET/.well-known/core?rt=total_autonomic_map&ep=light 1

Similarly, CoRE Link Format may be extended to support a “direct_autonomic_neighbor” web link relation name. For example a map the autonomic IoT nodes may be stored in an RD and sent to, or queried by, the autonomic neighbors via the web link relation to represent the map and the related resources.

Further, the CoRE RD lookup function may be extended to support a “total_autonomic_map” lookup. For example, such an interface may be defined as follows:
Interaction: IoT device->RD
CoAP Method: GET
URI template: /.well-known/core?rt=‘total_autonomic_map’

Adding a “total_autonomic_map” lookup may also require a definition in CoRE RD of an autonomic map forming processing functionality in the RD. For example, an IoT node may send a unicast request to the RD to get a copy of the autonomic neighbor map associated with a light 1, such as the following:
“CoAP GET/.well-known/core?rt=total_autonomic_map&ep=light 1”

In addition, a new CoAP header option may be used to indicate that delivery of a message being carried in a CoAP message may be routed by the receiving node over the autonomic control plane in the event that delivery of the message fails. Such a header option may include the identity of the autonomic node that the receiving node should attempt to route to when delivery by normal means fails.

Security modifications and extensions to standard CoAP may be useful for CoAP based autonomic control plane operation. For example, nodes other than an RD may use an application object security token as an input for use in “Raw Pubic Key Mode” operations. Such a token may be factory pre-loaded or field provisioned, and used as an alternate to certificate validation.

To pro-actively discover autonomic nodes, an RD may send a multicast message with a resource type set to “autonomic_device.” Such a message may be link-local in scope, but may also be site-local scope. For example, at initial system start up and periodically thereafter, an RD may send the following:
CoAP GET/.well-known/core?rt=autonomic_device

Based on responses to the multicast, the RD may form a map. For example, in each response the RD may examine: indoor location coordinates; an identifier such as from a security mechanism such as a raw public key or certificate; and the relevant access control list for each node.

After the map is formed, the RD transmits it to all autonomic nodes which are part of map. The transmissions may be unicast, and may be tailored to each receiving node. For example, each transmission may only provide information about the closes neighbors of the receiving node. Alternatively, the RD may send the map via a multicast transmission, whereby each node must extract its neighbor information from the map as a whole.

All information stored by RD regarding autonomic nodes, such as resources and the autonomic map, may be subject to access control, such as an identifier for each node from a security mechanism such as a raw public key or certificate. Under such access control, any query or operation on RD that affects autonomic resources will be subject to an access control check by the RD. By default, access to query and/or update resources on an autonomic node may be permitted, for example, only to the established neighbors of the node on the autonomic control map.

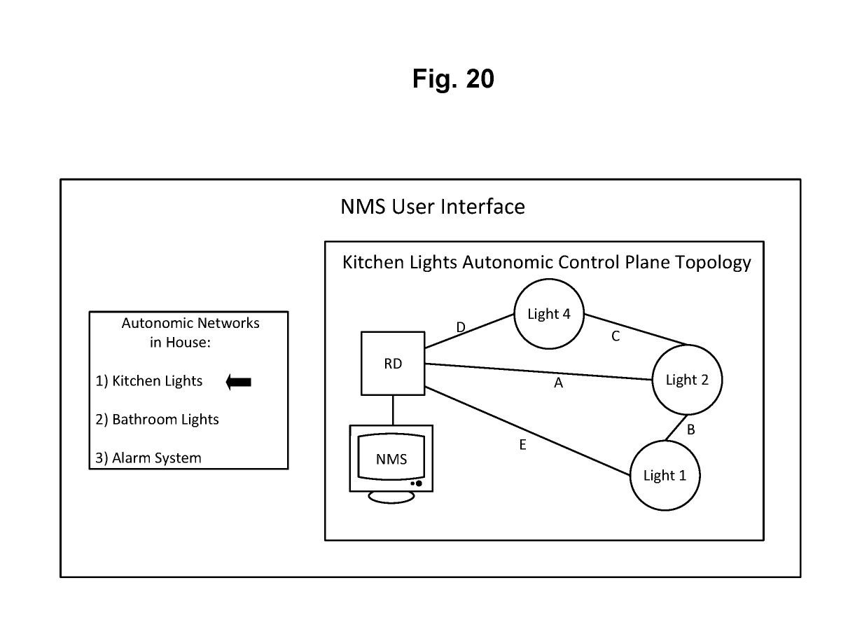

FIG. 20 illustrate an example graphical user interface (GUI) for a CoAP based autonomic control plane network. This interface may be available, for example, on an NMS system associated with the overall network where the autonomic network is running. In this example, the network and NMS are in a home, and the user is the home owner.

On the left side of GUI is a menu on which the user has selected to view the kitchen lights autonomic network. On the right side of the GUI is a depiction of a kitchen lights autonomic network, which includes the autonomic devices described in reference to, e.g., FIG. 3, plus the NMS. This GUI may be displayed, for example, on a touchscreen in the user's home.

A primary aim of such an interface may be to allow the home owner to graphically see and control key aspects of the autonomic network being controlled by the autonomic control plane. Following autonomic networking principles, the amount of details shown to the user should be limited to essential high level information about key points. However, an NMS GUI may permit highly detailed operations, such as allowing the user to set the RD as the root trust anchor in the security settings of the other nodes. Similarly, the user may be permitted to enter the object security token into the security settings of the RD and the other nodes.

The GUI of the RMS may be configured to provide certain outputs to the user, such as: a list of the autonomic networks in the house; a graphical view of the topology of the autonomic control plane of a selected network, such as those seen in FIG. 20; a graphical view of the backup autonomic routing tables, such as that shown in FIG. 11; and indications any of the autonomic devices unexpectedly disappearing from the autonomic network and/or other malfunctions otherwise detected.

An NMS supporting a GUI such as the one GUI depicted in FIG. 20 may also provide allow remote views and access to inputs and outputs. For example, the NMS may provide a password protected web interface a homeowner may access through a laptop or smartphone while the homeowner is out of the home.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effect the methods described herein. As used herein, the terms “apparatus,” “network apparatus,” “node,” “device,” and “network node” may be used interchangeably.

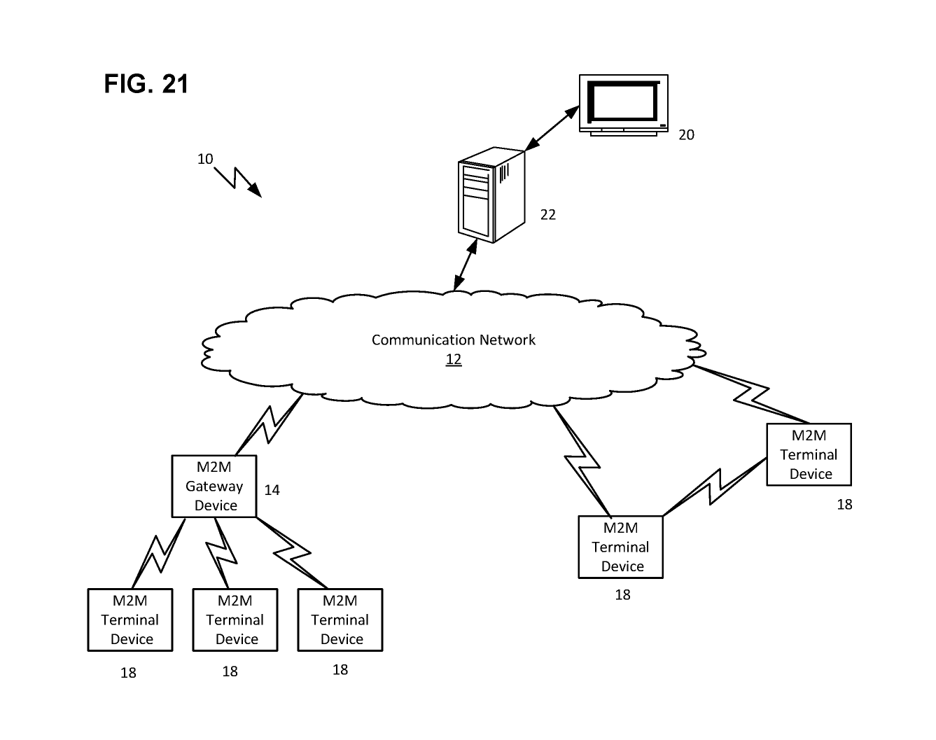

FIG. 21 shows an M2M/IoT/WoT device and gateway. The device and the gateway each support CoAP and may include support for a graphical user interface (GUI.) The autonomic functions described herein may be observed by user a number of ways. For example, when CoAP endpoints on the device and gateway exchange CoAP messages, a sniffer may be used to see what messages are exchanged.

Alternatively, if there is a GUI interface on the device or gateway, the GUI interface may be used to configure and display the parameters associated with the autonomic functions of the endpoints. The GUI may use filters to select what information is displayed. Similarly, the GUI may be used to obtain CoAP operational information via an internal API to the software stack running the CoAP endpoint. Therefore the GUI interface would be able to show the autonomic CoAP operations. For example, the GUI may show that an autonomic control plane has been established.

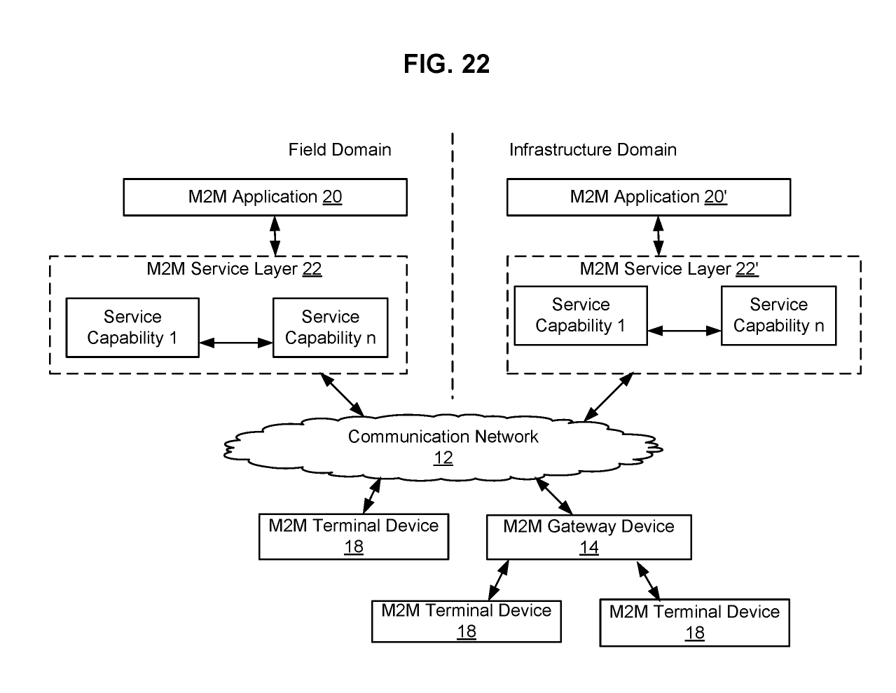

As shown in FIG. 22, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link. A M2M gateway 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

The service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

Referring to FIG. 22, the illustrated M2M service layer 22 in the field domain provides services for the M2M application 20, M2M gateways 14, and M2M devices 18 and the communication network 12. It will be understood that the M2M service layer 22 may communicate with any number of M2M applications, M2M gateways 14, M2M devices 18, and communication networks 12 as desired. The M2M service layer 22 may be implemented by one or more nodes of the network, which may comprise servers, computers, devices, or the like. The M2M service layer 22 provides service capabilities that apply to M2M devices 18, M2M gateways 14, and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ in the infrastructure domain and the underlying communication network 12. M2M service layer 22′ also provides services for the M2M gateways 14 and M2M devices 18 in the field domain. It will be understood that the M2M service layer 22′ may communicate with any number of M2M applications, M2M gateways and M2M devices. The M2M service layer 22′ may interact with a service layer by a different service provider. The M2M service layer 22′ may be implemented by one or more nodes of the network, which may comprise servers, computers, devices, virtual machines (e.g., cloud computing/storage farms, etc.) or the like.

Referring also to FIG. 22, the M2M service layers 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layers 22 and 22′ also enable M2M applications 20 and 20′ to communicate through various networks, e.g., network 12, in connection with the services that the service layers 22 and 22′ provide.

The M2M applications 20 and 20′ may include applications in various industries such as, without limitation, transportation, health and wellness, connected home, energy management, asset tracking, and security and surveillance. As mentioned above, the M2M service layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

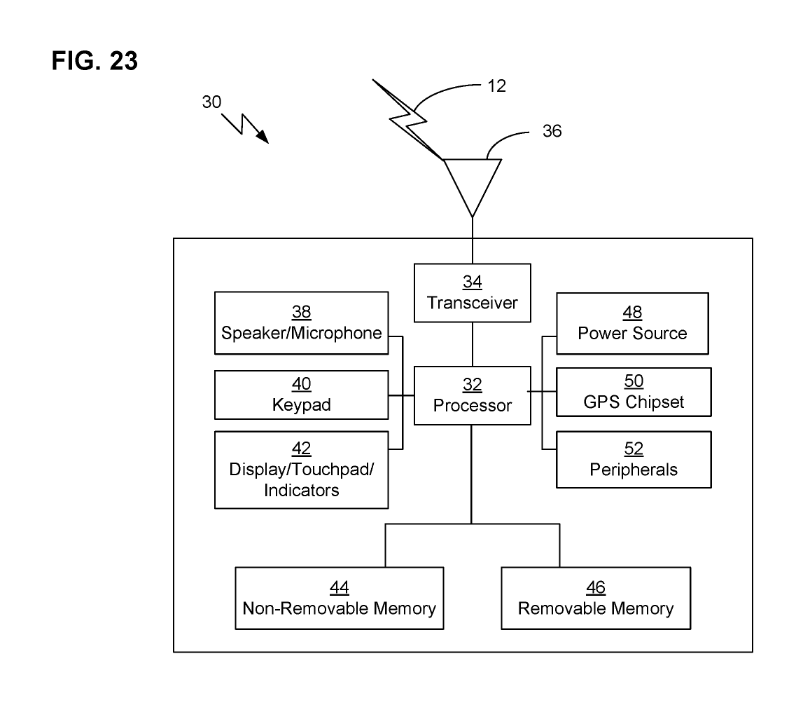

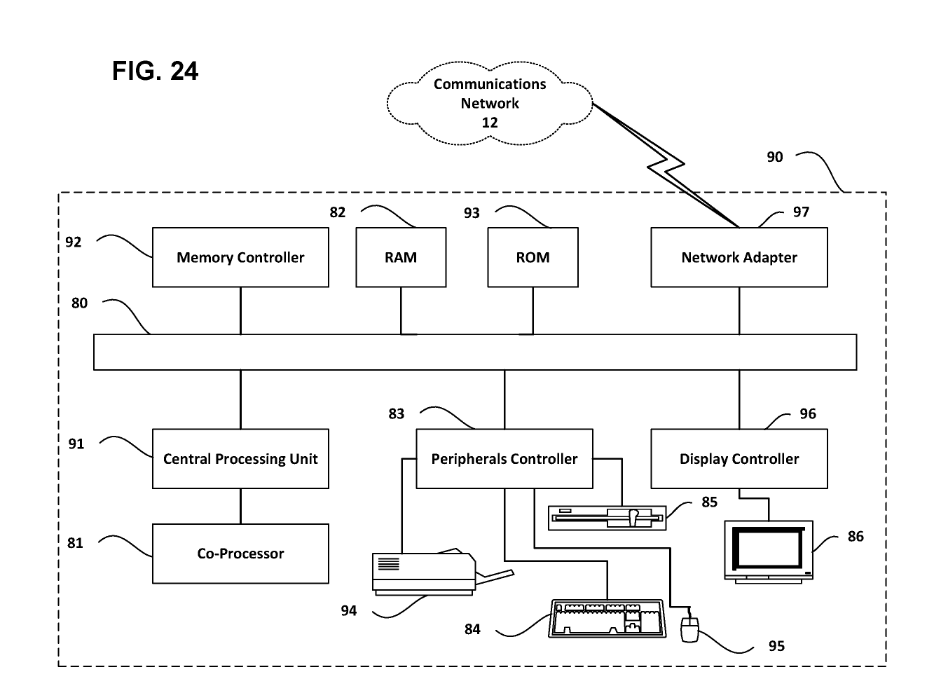

Generally, a service layer, such as the service layers 22 and 22′ illustrated in FIGS. 21 and 22, defines a software middleware layer that supports value-added service capabilities through a set of Application Programming Interfaces (APIs) and underlying networking interfaces. Both the ETSI M2M and oneM2M architectures define a service layer. ETSI M2M's service layer is referred to as the Service Capability Layer (SCL). The SCL may be implemented in a variety of different nodes of the ETSI M2M architecture. For example, an instance of the service layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M service layer supports a set of Common Service Functions (CSFs) (e.g., service capabilities). An instantiation of a set of one or more particular types of CSFs is referred to as a Common Services Entity (CSE) which can be hosted on different types of network nodes (e.g. infrastructure node, middle node, application-specific node). The Third Generation Partnership Project (3GPP) has also defined an architecture for machine-type communications (MTC). In that architecture, the service layer and the service capabilities it provides are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the service layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a service layer or component thereof may be implemented in the form of software running on a network node (e.g., server, computer, gateway, device or the like) having the general architecture illustrated in FIG. 23 or FIG. 24 described below.

Autonomic control plane functionality may be incorporated into any node. For example, controller-like functions, such as autonomic node discover and mapping may be incorporated into service layer 22 and/or server layer 22′.

Further, the methods and functionalities described herein may be implemented as part of an M2M network that uses a Service Oriented Architecture (SOA) and/or a Resource-Oriented Architecture (ROA) to access services.

FIG. 23 is a block diagram of an example hardware/software architecture of a node of a network, such as one of the devices illustrated in FIGS. 2, 3, 5-18, and/or 20-24, which may operate as an M2M server, gateway, device, or other node in an M2M network such as that illustrated in FIGS. 21 and 22. As shown in FIG. 23, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements aspects of the autonomic functionality described herein.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 23, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the transmitting and receiving steps described herein, e.g., as described in reference to FIGS. 2, 3, 5-18, and/or 21-24, and in the claims. While FIG. 23 depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, devices, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 23 as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42 to reflect the status of an M2M service layer session migration or sharing or to obtain input from a user or display information to a user about the node's session migration or sharing capabilities or settings. In another example, the display may show information with regard to a session state.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., finger print) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 24 is a block diagram of an exemplary computing system 90 which may also be used to implement one or more nodes of a network, such as the devices illustrated in FIGS. 2, 3, 5-18, and/or 20-24, which may operate as an M2M server, gateway, device, or other node in an M2M network such as that illustrated in FIGS. 21 and 22. Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 and/or coprocessor 81 may receive, generate, and process data related to the disclosed systems and methods for E2E M2M service layer sessions, such as autonomic functions.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97, that may be used to connect computing system 90 to an external communications network, such as network 12 of FIG. 21 and FIG. 22, to enable the computing system 90 to communicate with other nodes of the network. The communication circuitry, alone or in combination with the CPU 91, may be used to perform the transmitting and receiving steps described herein in reference to FIGS. 2, 3, 5-18, and/or 20-24, and in the claims.

It is understood that any or all of the systems, methods, and processes described herein may be embodied in the form of computer executable instructions (e.g., program code) stored on a computer-readable storage medium. Such instructions, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not include signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium that can be used to store the desired information and that can be accessed by a computer.

In describing preferred embodiments of the subject matter of the present disclosure, as illustrated in the figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An apparatus comprising a processor, a memory, and communication circuitry, the apparatus being connected to a CoAP communications network via its communication circuitry, the apparatus further comprising computer-executable instructions stored in the memory of the apparatus which, when executed by the processor of the apparatus, cause the apparatus to:
a. perform a first autonomic network or node management function;
b. store and access at least a portion of a map of an autonomic control plane, the map of the autonomic control plane comprising one or more addresses of network nodes belonging to a confirmed group of CoAP nodes with sufficient security credentials to participate with each other in more or more autonomic control functions; and
c. transmit an autonomic control plane message to a node on the autonomic control plane, the message comprising a first security credential, and the address of the message being determined from the map.

2. The apparatus of claim 1, wherein the computer-executable instructions cause the apparatus to further:
a. transmit a query to candidate nodes in the network, where the query comprises a second security credential, and where the query asks each candidate node whether the candidate node is configured to perform an autonomic function;
b. receive affirmative responses from one or more candidate nodes;
c. form the map from the addresses of the candidate nodes responding affirmatively;
d. transmit, to each of the candidate nodes responding affirmatively, a confirmation, the confirmation confirming membership in the autonomic control plane, where the confirmation comprises an indication of a neighbor node with which the node may form a pairwise communication channel in the autonomic control plane.

3. The apparatus of claim 2, wherein the apparatus implements a CoAP resource directory.

4. The apparatus of claim 2, wherein the indication of the neighbor node comprises a CoRE link format device level attribute signifying autonomic neighbor status.

5. The apparatus of claim 1, wherein the first security credential is a certificate.

6. The apparatus of claim 1, wherein the first security credential is a derived from a raw public key.

7. The apparatus of claim 1, wherein the first security credential is a derived from a raw public key and an object security token.

8. The apparatus of claim 1, wherein the computer-executable instructions cause the apparatus to further:
a. transmit a data plane message, the data plane message comprising an option signifying that the data plane message should be forwarded via the autonomic control plane in the case that transmission is unsuccessful.

9. The apparatus of claim 1, wherein the computer-executable instructions cause the apparatus to further:
a. provide a graphical user interface whereby a user may see the portion of the map.

10. The apparatus of claim 1, wherein the computer-executable instructions cause the apparatus to further:
a. provide a graphical user interface whereby a user may configure and/or perform a second autonomic network or node management function.

11. A method performed by an apparatus of a CoAP communications network, the method comprising:
a. performing a first autonomic network or node management function;
b. storing and accessing at least a portion of a map of an autonomic control plane, the map of the autonomic control plane comprising one or more addresses of network nodes belonging to a confirmed group of CoAP nodes with sufficient security credentials to participate with each other in more or more autonomic control functions; and
c. transmitting an autonomic control plane message to a node on the autonomic control plane, the message comprising a first security credential, and the address of the message being determined from the map.

12. The method of claim 1, further comprising:
a. transmitting a query to candidate nodes in the network, where the query comprises a second security credential, and where the query asks each candidate node whether the candidate node is configured to perform an autonomic function;
b. receiving affirmative responses from one or more candidate nodes;
c. forming the map from the addresses of the candidate nodes responding affirmatively;
d. transmitting, to each of the candidate nodes responding affirmatively, a confirmation, the confirmation confirming membership in the autonomic control plane, where the confirmation comprises an indication of a neighbor node with which the node may form a pairwise communication channel in the autonomic control plane.

13. The method of claim 12, wherein the node is a CoAP resource directory.

14. The method of claim 12, wherein the indication of the neighbor node comprises a CoRE link format device level attribute signifying autonomic neighbor status.

15. The method of claim 10, wherein the first security credential is a certificate.

16. The method of claim 10, wherein the first security credential is derived from a raw public key.

17. The method of claim 10, wherein the first security credential is derived from a raw public key and an object security token.

18. The method of claim 10, further comprising:
a. transmitting a data plane message, the data plane message comprising a CoAP option signifying that the data plane message should be forwarded via the autonomic control plane in the case that transmission is unsuccessful.

19. The method of claim 10, further comprising:
a. providing a graphical user interface whereby a user may see the portion of the map.

20. The method of claim 10, further comprising:
a. providing a graphical user interface whereby a user may configure perform a second autonomic network or node management function.
